(19) United States
(12) Patent Application Publication
(10) Pub. No.: US 2026/0278802 A1
(43) Pub. Date: Sep. 17, 2026

(54) IMAGE PROCESSING APPARATUS AND IMAGE PROCESSING METHOD

(71) Applicant: CANON KABUSHIKI KAISHA, Tokyo (JP)

(72) Inventor: YOHEI FUJITANI, Kanagawa (JP)

(21) Appl. No.: 19/546,612

(22) Filed: Feb. 23, 2026

(30) Foreign Application Priority Data
Mar. 17, 2025 (JP) 2025-042422

(51) Int. Cl. G06T 7/11

(52) U.S. Cl. CPC G06T 7/11; G06T 2207/20132

(57) ABSTRACT

An image processing apparatus includes: a processor; and a memory storing a program which, when executed by the processor, causes the image processing apparatus to: execute acquisition processing of acquiring image data configured to be able to acquire a plurality of images with different focuses; and execute assignment processing of assigning, in a case where the image data is edited, history information to an edited image data, wherein, in the assignment processing, a change in a composition ratio when the plurality of images are combined is not considered as editing of the image data.

### BACKGROUND

### Field of the Technology

The present disclosure relates to an image processing apparatus and an image processing method.

### Description of the Related Art

In related art, a method for reducing setting errors of a camera at the time of imaging and obtaining a desired imaged image by changing desired imaging parameters such as exposure correction and white balance after imaging and performing development processing on an imaged RAW image has been employed. In addition, a method for recording a plurality of images imaged at the same exposure timing and having different focus positions as parallax information in one file and finely adjusting a focus position by using a difference in the focus position has been known. An image having parallax information is recorded, and thus, it is possible to perform development processing by adjusting a focus position after imaging.

C2PA, which is a standardization organization, develops a technical specification for ensuring the origin and reliability of content in order to enable publishers, creators, and consumers to track the origin of media, and the importance of ensuring authenticity of the content is gaining attention. In the standard defined by the C2PA, an image generated at the time of imaging or editing can include Manifest as data for ensuring authenticity. The Manifest can store a claim generator (camera name, software name, or the like), Hash, claim signature (digital signature), a thumbnail image, and the like. It can be determined whether the image is “original” or “edited” by referring to the manifest.

In addition, there is a demand for a mechanism for ensuring authenticity of edited content generated by legitimate editing processing by an imaging device or the like. Japanese Patent Laid-Open No. 2024-076326 discloses a technology for ensuring the authenticity of the edited content from the time of generation by generating a hash value of the edited content and registering the hash value in a blockchain.

However, when the authenticity is ensured as the edited content for all the editing processing, the content is determined to be edited even in a case where minor editing processing such as development processing is performed by adjusting the focus position.

### SUMMARY

The present disclosure provides an image processing apparatus capable of handling an image as an unedited image even though minor editing processing such as adjustment of a focus position is performed.

An image processing apparatus according to the present disclosure includes: a processor; and a memory storing a program which, when executed by the processor, causes the image processing apparatus to: execute acquisition processing of acquiring image data configured to be able to acquire a plurality of images with different focuses; and execute assignment processing of assigning, in a case where the image data is edited, history information to an edited image data, wherein, in the assignment processing, a change in a composition ratio when the plurality of images are combined is not considered as editing of the image data.

Features of the present disclosure will become apparent from the following description of embodiments with reference to the attached drawings. The following description of embodiments is described by way of example.

### BRIEF DESCRIPTION OF THE DRAWINGS

FIG. 1 is a diagram illustrating a configuration of a digital camera.

FIGS. 2A to 2C are diagrams for describing a method for detecting a defocus direction and a defocus amount.

FIGS. 3A and 3B are diagrams illustrating an outline of recorded contents of an image file in RAW format.

FIGS. 4A and 4B are diagrams illustrating an outline of recorded contents of an image file in JPEG format.

FIGS. 5A and 5B are diagrams illustrating an outline of recorded contents of an image file not including authenticity certification information.

FIG. 6 is a flowchart illustrating processing of the digital camera.

FIG. 7A is a diagram illustrating a menu screen for giving an instruction about RAW development processing; FIG. 7B is a diagram illustrating a focus position correction screen.

FIG. 8 is a flowchart illustrating development processing with adjusting a focus position.

FIG. 9 is a flowchart illustrating file generation processing according to a first embodiment.

FIG. 10 is a flowchart of generation processing of the authenticity certification information according to the first embodiment.

FIG. 11 is a flowchart illustrating development processing without adjusting the focus position.

FIG. 12 is a flowchart of generation processing of authenticity certification information according to a third embodiment.

### DESCRIPTION OF THE EMBODIMENTS

Hereinafter, embodiments of the present disclosure will be described with reference to the drawings. Note that the present disclosure is not limited to the following embodiments. A plurality of features described in each embodiment are not necessarily required, and may be voluntarily combined. In the drawings, the same or similar configurations are denoted by the same reference numerals, and redundant description is omitted.

An image processing apparatus according to the present disclosure may be a device capable of reading an image recorded in a recording device and displaying the read image on a display device, and may be, for example, a smartphone, a tablet terminal, a personal computer (PC), or the like.

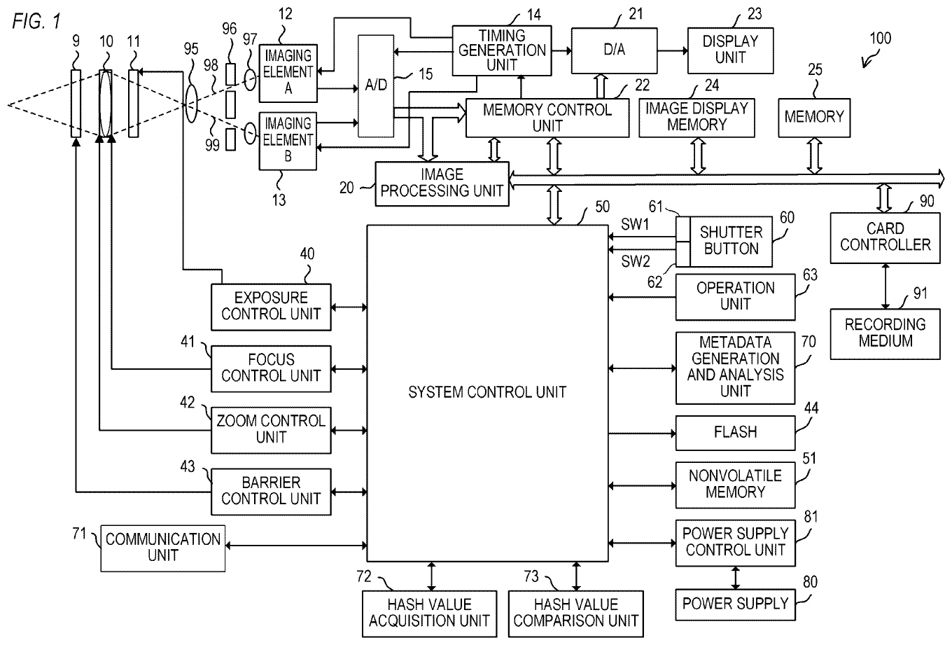

FIG. 1 is a diagram illustrating a configuration of a digital camera 100 as an example of the image processing apparatus according to the present disclosure. The digital camera 100 includes a barrier 9, an imaging lens 10, a shutter 11, an imaging element A12, an imaging element B13, a barrier control unit 43, a field lens 95, an aperture mask 96, and a secondary coupling lens 97.

The barrier 9 is a protective member that covers an imaging unit including the imaging lens 10 of the digital camera 100 to prevent dirt and damage on the imaging unit. An operation of the barrier 9 is controlled by the barrier control unit 43. The imaging lens 10 forms an optical image on imaging surfaces of the imaging element A12 and the imaging element B13 via the field lens 95, the aperture mask 96, and the secondary coupling lens 97.

The shutter 11 has an aperture function. The imaging element A12 and the imaging element B13 are, for example, CCD and CMOS sensors. The imaging element A12 and the imaging element B13 convert the optical images formed on the imaging surfaces into electrical signals by the imaging lens 10, the field lens 95, the aperture mask 96, and the secondary coupling lens 97 via the shutter 11.

In addition, the digital camera 100 includes a timing generator 14, an A/D converter 15, an image processing unit 20, a D/A converter 21, a memory control unit 22, a display unit 23, an image display memory 24, a memory 25, and a system control unit 50.

The timing generator 14 is controlled by the memory control unit 22 and the system control unit 50. The timing generator 14 supplies clock signals and control signals to the imaging element A12, the imaging element B13, the A/D converter 15, and the D/A converter 21.

The A/D converter 15 converts analog image signals output from the imaging element A12 and the imaging element B13 into digital image signals. The digital image signals converted by the A/D converter 15 are written, as so-called pieces of RAW image data, to the memory 25. The A/D converter 15 generates development parameters corresponding to the pieces of RAW image data on the basis of information at the time of imaging, and writes the generated development parameters to the memory 25. The development parameter includes various parameters used in image processing when an image is recorded in a file format such as a JPEG scheme, such as exposure, white balance, color space, and contrast.

The image processing unit 20 performs various types of image processing such as predetermined pixel interpolation processing, color conversion processing, correction processing, resizing processing, and image composition processing on the data from the A/D converter 15 or the memory control unit 22. The image processing unit 20 performs predetermined image processing and arithmetic processing by using pieces of image data obtained by imaging, and provides the obtained arithmetic result to the system control unit 50. The system control unit 50 realizes autofocus (AF) processing, automatic exposure (AE) processing, and flash preliminary emission (EF) processing by controlling an exposure control unit 40 and a focus control unit 41 on the basis of the provided arithmetic result.

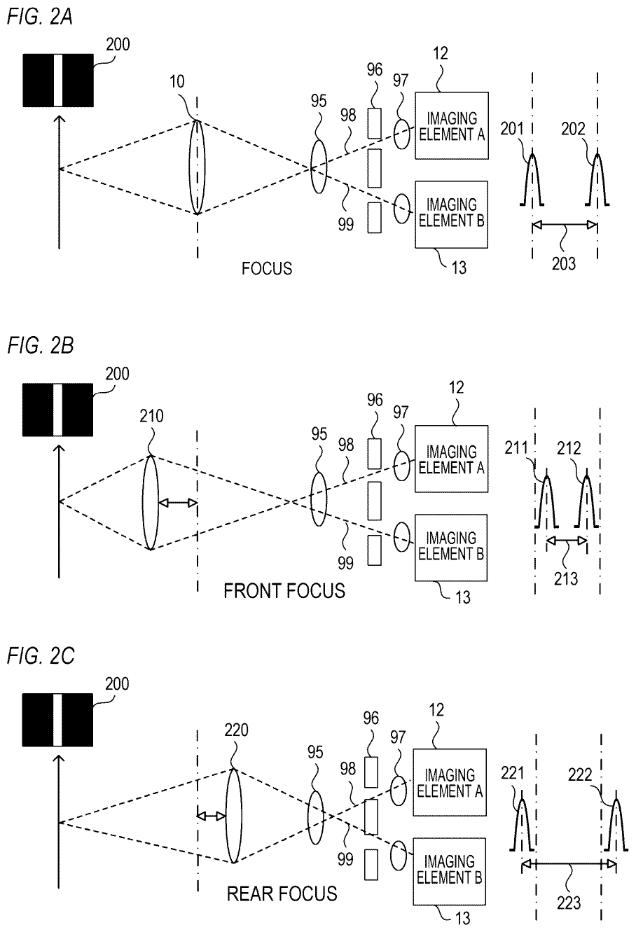

The field lens 95, the aperture mask 96, and the secondary coupling lens 97 are arranged in front of the imaging element A12 and the imaging element B13, and thus, input signals divided by the secondary coupling lens 97 are formed as images on the imaging element A12 and the imaging element B13, respectively. The images formed on the imaging element A12 and the imaging element B13 are also referred to as an A image and a B image, respectively. The A image and the B image are imaged at the same exposure timing. The system control unit 50 can detect a defocus direction and a defocus amount by detecting relative positions of output signals of an A-image input signal 98 and a B-image input signal 99. A method for detecting the defocus direction and the defocus amount will be described with reference to FIGS. 2A to 2C.

In the example of FIG. 1, the field lens 95, the aperture mask 96, and the secondary coupling lens 97 are arranged between the imaging lens 10, and the imaging element A12 and the imaging element B13, and thus, the imaging element A12 and the imaging element B13 can acquire a phase difference. The present disclosure is not limited to the configuration of FIG. 1, and the field lens 95, the aperture mask 96, and the secondary coupling lens 97 may not be arranged as long as the phase difference can be detected by the imaging element A12 and the imaging element B13.

The image processing unit 20 can perform predetermined arithmetic processing by using the pieces of image data obtained by imaging, and perform auto white balance (AWB) processing on the basis of the obtained arithmetic result. The image processing unit 20 can read the pieces of image data stored in the memory 25 and perform compression processing or decompression processing. For example, the image processing unit 20 performs lossless compression processing on uncompressed RAW data. In addition, the image processing unit 20 performs decompression processing of data compressed by a scheme such as JPEG, MPEG-4 AVC, or high efficiency video coding (HEVC). The image processing unit 20 writes the pieces of image data on which various types of processing are performed to the memory 25.

The image processing unit 20 performs predetermined arithmetic processing by using the pieces of image data obtained by imaging, and performs editing processing of various types of image data. Specifically, the image processing unit 20 can perform trimming processing of adjusting a display range and a size of the image by hiding unnecessary portions around the pieces of image data and resizing processing of changing a size by enlarging or reducing pieces of image data and display elements of a screen. In addition, the image processing unit 20 can perform RAW development processing for generating pieces of image data by applying image processing such as color conversion to data on which the compression processing or the decompression processing is performed and converting the data into a JPEG scheme. In addition, the image processing unit 20 can perform video clipping processing of clipping a designated frame in a moving image format such as MPEG-4, converting the frame into a JPEG scheme, and storing the frame.

The image processing unit 20 performs predetermined arithmetic processing by using the pieces of image data and performs image comparison processing on various types of image data. Specifically, the image processing unit 20 performs decompression processing on pieces of image data to be compared in accordance with each compression scheme, and compares the decompressed images. The image processing unit 20 can determine whether or not the images to be compared coincide with each other and how much a difference is.

The image processing unit 20 performs processing of superimposing an on-screen display (OSD) on pieces of display image data. The OSD can display a menu, any characters, and the like to be displayed on the display unit 23 together with the pieces of image data.

The image processing unit 20 performs object detection processing of detecting objects present in the pieces of image data by using the pieces of input image data, distance information with objects obtained from the imaging element A12, the imaging element B13, and the like at the time of imaging, and the like and acquiring information of an object region. The image processing unit 20 can acquire information such as a position and a size of the object region in the image, an inclination of the object, and the certainty of the object.

The image processing unit 20 includes a composition processing circuit that combines a plurality of pieces of image data. The image processing unit 20 may overwrite pixels or combine pixels by weighted addition. The image processing unit 20 can generate an image through which a background can be seen by performing weighted addition.

The image processing unit 20 can generate a composite image by performing comparative brightness composition processing of comparing brightness of pixels of pieces of image data to be combined with each other and selecting brighter pixels. In addition, the image processing unit 20 can generate a composite image by performing comparative darkness composition processing of comparing brightness of the pixels of the pieces of image data to be combined with each other and selecting darker pixels.

The memory control unit 22 controls the A/D converter 15, the timing generator 14, the image processing unit 20, the image display memory 24, the D/A converter 21, and the memory 25. The pieces of RAW image data generated by the A/D converter 15 are written to the image display memory 24 or the memory 25 via the image processing unit 20 and the memory control unit 22. The pieces of RAW image data generated by the A/D converter 15 may be directly written to the image display memory 24 or the memory 25 via the memory control unit 22 without using the image processing unit 20.

The pieces of display image data written to the image display memory 24 are displayed on the display unit 23 via the D/A converter 21. The display unit 23 is, for example, a thin film transistor liquid crystal display (TFT LCD). The digital camera 100 can realize an electronic finder function of displaying a live image by sequentially displaying the pieces of image data obtained by imaging on the display unit 23.

The memory 25 has a storage amount sufficient to store a predetermined number of still images and moving images for a predetermined time, and stores the imaged still images and moving images. The memory 25 can also be used as a work region for the system control unit 50. The system control unit 50 controls the overall digital camera 100.

In addition, the digital camera 100 includes an exposure control unit 40, a focus control unit 41, a zoom control unit 42, a flash 44, a nonvolatile memory 51, a shutter button 60, an operation unit 63, and a metadata generation and analysis unit 70. In addition, the digital camera 100 includes a communication unit 71, a hash value acquisition unit 72, a hash value comparison unit 73, a power supply 80, a power supply control unit 81, a card controller 90, and a recording medium 91.

The exposure control unit 40 controls the shutter 11 having an aperture function. The exposure control unit 40 has a flash dimming function by interlocking with the flash 44. The focus control unit 41 performs focus adjustment by driving a focus lens (not illustrated) included in the imaging lens 10 on the basis of an instruction from the system control unit 50. The zoom control unit 42 controls zooming by driving a zoom lens (not illustrated) included in the imaging lens 10. The flash 44 has a projection function of AF assist light and a flash dimming function.

The nonvolatile memory 51 is an electrically erasable and recordable nonvolatile memory. The nonvolatile memory 51 is, for example, an electrically erasable and programmable read-only memory (EEPROM). Note that the nonvolatile memory 51 records various types of image data in addition to programs.

The shutter button 60 includes a first shutter switch 61 and a second shutter switch 62. The first shutter switch 61 is turned on in the middle of an operation of the shutter button 60 in response to so-called half-press (imaging preparation instruction) and outputs a first shutter switch signal SW1. The system control unit 50 starts imaging preparation processing such as AF processing, AE processing, AWB processing, and EF processing in accordance with the first shutter switch signal SW1.

The second shutter switch 62 is turned on at the completion of the operation of the shutter button 60 in response to so-called full-press (imaging instruction) and outputs a second shutter switch signal SW2. In response to the second shutter switch signal SW2, the system control unit 50 starts a series of imaging operations including exposure processing, development processing, and recording processing.

In the exposure processing, the system control unit 50 writes, as the pieces of RAW image data, the signals read from the imaging element A12 and the imaging element B13 to the memory 25 via the A/D converter 15 and the memory control unit 22. In the development processing, the system control unit 50 develops the pieces of RAW image data written to the memory 25 by using the arithmetic results in the image processing unit 20 and the memory control unit 22, and writes, as the pieces of image data, the pieces of developed RAW image data in the memory 25. In the recording processing, the system control unit 50 reads the pieces of image data from the memory 25 and compresses the pieces of image data read by the image processing unit 20. The system control unit 50 stores the pieces of compressed image data in the memory 25 and writes the pieces of compressed image data to the recording medium 91 via the card controller 90.

The operation unit 63 is an operation member such as various buttons and a touch panel. The operation unit 63 includes, for example, a power button, a menu button, a mode switching switch for switching between an imaging mode, a reproduction mode, and another special imaging mode, a four-way key, a set button, a macro button, and a multi-screen reproduction page renewal button. In addition, the operation unit 63 includes, for example, a flash setting button, a single imaging, continuous imaging, and self-timer switching button, a menu movement + (plus) button, a menu movement − (minus) button, an imaged image quality selection button, an exposure correction button, a date and time setting button, and the like.

When the pieces of image data are recorded in the recording medium 91, the metadata generation and analysis unit 70 generates metadata to be stored in the image data on the basis of information at the time of imaging. The metadata to be generated is, for example, metadata defined in an exchangeable image file format (Exif) standard. When the pieces of image data recorded in the recording medium 91 are read, the metadata generation and analysis unit 70 analyzes the metadata assigned to the image data. The metadata includes, for example, setting information at the time of imaging, information regarding the image data, and feature information of the object included in the image data. In addition, when moving image data is recorded, the metadata generation and analysis unit 70 can generate and assign metadata to each frame.

The power supply 80 is a primary battery such as alkaline battery and lithium batteries, a secondary battery such as NiCd, NiMH, and Li batteries, an AC adapter, or the like. The power supply control unit 81 supplies power supplied from the power supply 80 to each unit of the digital camera 100.

The card controller 90 controls transmission and reception of data to and from the recording medium 91 such as a memory card. The recording medium 91 is, for example, a memory card. The recording medium 91 records the images (still image and moving image) imaged by the digital camera 100. The communication unit 71 includes a communication circuit for performing transmission and reception. The communication circuit may be specifically wireless communication such as Wi-Fi or Bluetooth (trademark), or may be wired communication such as Ethernet or USB.

The hash value acquisition unit 72 acquires (calculates) a hash value by executing a hash function on the image data input by the system control unit 50. Note that the hash value may be acquired by the system control unit 50 instead of the hash value acquisition unit 72. The system control unit 50 may acquire a hash value by executing a hash function on not the entire image data but a part of the image data.

The hash value comparison unit 73 receives a hash value acquired by the metadata generation and analysis unit 70 from the image data that performs authenticity certification. The hash value comparison unit 73 can determine the authenticity of the image data by comparing the hash value received from the metadata generation and analysis unit 70 with the hash value generated by the hash value acquisition unit 72. In a case where these two hash values are the same, the hash value comparison unit 73 determines that the image data as an authenticity determination target is not falsified (is true). On the other hand, in a case where the two hash values are different, the hash value comparison unit 73 determines that the image data as the authenticity determination target is falsified (is not true or is false).

In a case where the image data as the authenticity determination target input by the system control unit 50 does not include the hash value, the system control unit 50 determines that whether or not the image data is falsified is unknown (neither true nor false). Note that the comparison of the hash values may be performed by the system control unit 50 instead of the hash value comparison unit 73.

FIGS. 2A to 2C are diagrams for describing a method for detecting a defocus direction and a defocus amount. FIG. 2A illustrates outputs of the imaging element A12 and the imaging element B13 when the focus control unit 41 controls the imaging lens 10 to be in focus. An object pattern 200 forms images on the imaging element A12 and the imaging element B13 via the imaging lens 10, the field lens 95, the aperture mask 96, and the secondary coupling lens 97. A focus image interval 203 is an interval between an A-image output signal 202 and a B-image output signal 201, and serves as a reference for comparison with a front-focus image interval 213 and a rear-focus image interval 223 illustrated in FIGS. 2B and 2C.

FIG. 2B illustrates outputs of the imaging element A12 and the imaging element B13 when the focus control unit 41 controls the imaging lens 10 illustrated in FIG. 2A to move toward the object pattern 200 up to a position of the imaging lens 210 illustrated in FIG. 2B, and becomes front focus. The object pattern 200 is formed as the images on the imaging element A12 and the imaging element B13 via the imaging lens 210, the field lens 95, the aperture mask 96, and the secondary coupling lens 97. The front-focus image interval 213 is an interval between an A-image output signal 212 and a B-image output signal 211, and is narrower than the reference focus image interval 203.

FIG. 2C illustrates outputs of the imaging element A12 and the imaging element B13 when the focus control unit 41 controls the imaging lens 10 illustrated in FIG. 2A to move toward an imaging device up to a position of the imaging lens 220 illustrated in FIG. 2C, and becomes rear focus. The object pattern 200 is formed as the images on the imaging element A12 and the imaging element B13 via the imaging lens 220, the field lens 95, the aperture mask 96, and the secondary coupling lens 97. The rear-focus image interval 223 is an interval between an A-image output signal 222 and a B-image output signal 221, and is wider than the reference focus image interval 203. The system control unit 50 can detect a defocus direction and a defocus amount of focus, front focus, rear focus, and the like on the basis of a difference between the image interval between the A image output signal and the B image output signal and the reference focus image interval 203.

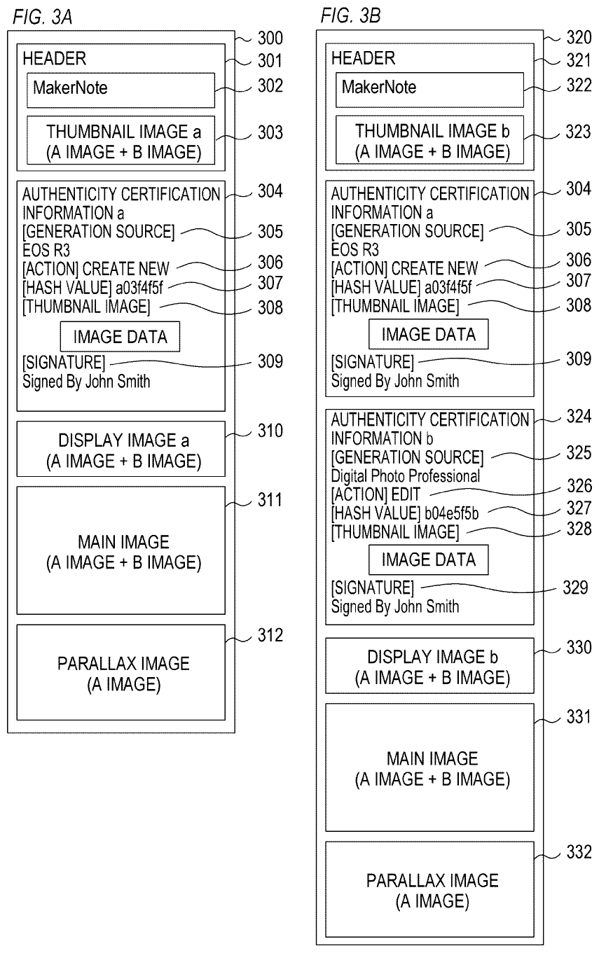

FIGS. 3A and 3B are diagrams illustrating an outline of recorded contents of an image file (image data) in RAW format. The images imaged by the imaging element A12 and the imaging element B13 are images imaged at the same exposure timing, and are also referred to as an A image and a B image, respectively.

FIG. 3A illustrates an outline of recorded contents of a newly created image file 300 in RAW format. The image file 300 includes regions in which a header 301, authenticity certification information a 304, a display image a (A image+B image) 310, a main image (A image+B image) 311, and a parallax image (A image) 312 are recorded. Metadata according to the Exif standard generated by the metadata generation and analysis unit 70, MakerNote 302, and a thumbnail image a (A image+B image) 303 are recorded in the region of the header 301. The region of the authenticity certification information a 304 records information for certifying authenticity.

The authenticity certification information a 304 includes pieces of information of a generation source 305, an action 306, a hash value 307, a thumbnail image 308, and a signature 309. The generation source 305 indicates a camera name and a software name that have generated the image file 300. The action 306 indicates information of an operation on content. The operation on the content includes, for example, operations such as new creation of content, editing of content, and deletion of content.

The hash value 307 indicates, for example, a hash value for the display image a (A image+B image) 310, the thumbnail image a (A image+B image) 303, and the header 301. The thumbnail image 308 is a thumbnail image when the authenticity certification information a 304 is added. The signature 309 indicates signature information of the image file 300.

The image file 300 illustrated in FIG. 3A is recorded as an unedited image file generated at the time of imaging, “create new” in the action 306. Note that, in FIG. 3A, “EOS R3” is recorded in the generation source 305, and “create new” is recorded in the action 306. However, “EOS R3” may not be recorded in the generation source 305, and “create new by camera” may be recorded in the action 306.

The main image (A image+B image) 311 is a digital image signal converted by the A/D converter 15, and is an image in which both the signals of the A-image input signal 98 and the B-image input signal 99 are recorded without being compressed. The parallax image (A image) 312 is a digital image signal converted by the A/D converter 15, and is an image in which the signal of the A-image input signal 98 is recorded without being compressed. The thumbnail image a (A image+B image) 303 and the display image a (A image +B image) 310 are digital image signals converted by the A/D converter 15, and are images recorded by performing development processing on both the signals of the A-image input signal 98 and the B-image input signal 99.

FIG. 3B illustrates an image file 320 in RAW format in a case where the thumbnail image a (A image+B image) 303 or the display image a (A image+B image) 310 of the image file 300 in RAW format is edited. The image file 320 recorded after editing includes regions in which a header 321, authenticity certification information a 304, authenticity certification information b 324, a display image b (A image+B image) 330, a main image (A image+B image) 331, and a parallax image (A image) 332 are recorded.

Metadata according to the Exif standard generated by the metadata generation and analysis unit 70 on the basis of the editing result, the MakerNote 322, and an edited thumbnail image b (A image+B image) 323 are recorded in the region of the header 321. The image file 320 includes authenticity certification information a 304 duplicated from the image file 300 which is the editing source and added authenticity certification information b 324. The system control unit 50 can determine whether or not the image file 320 is edited on the basis of the added authenticity certification information b 324.

The added authenticity certification information b 324 includes pieces of information of a generation source 325, an action 326, a hash value 327, a thumbnail image 328, and a signature 329. Since the image file 320 is edited, the generation source 325 indicates software or the like used for editing the image file 320. In the example of FIG. 3B, the generation source 325 indicates a software name of “Digital Photo Professional”. The action 326 is recorded as “edit”. The action 326 is not limited to “edit”, and specific editing operations such as “transform”, “crop”, “resize”, “composition”, and “delete” may be recorded.

The hash value 327 indicates, for example, a hash value for the edited display image b (A image+B image) 330, the thumbnail image b (A image+B image) 323, and the header 321. The thumbnail image 328 is a thumbnail image when the authenticity certification information b 324 is added. The signature 329 indicates signature information of the image file 320.

The main image (A image+B image) 331 and the parallax image (A image) 332 are pieces of data obtained by directly duplicating the main image (A image+B image) 311 and the parallax image (A image) 312 of the image file 300 which is the editing source.

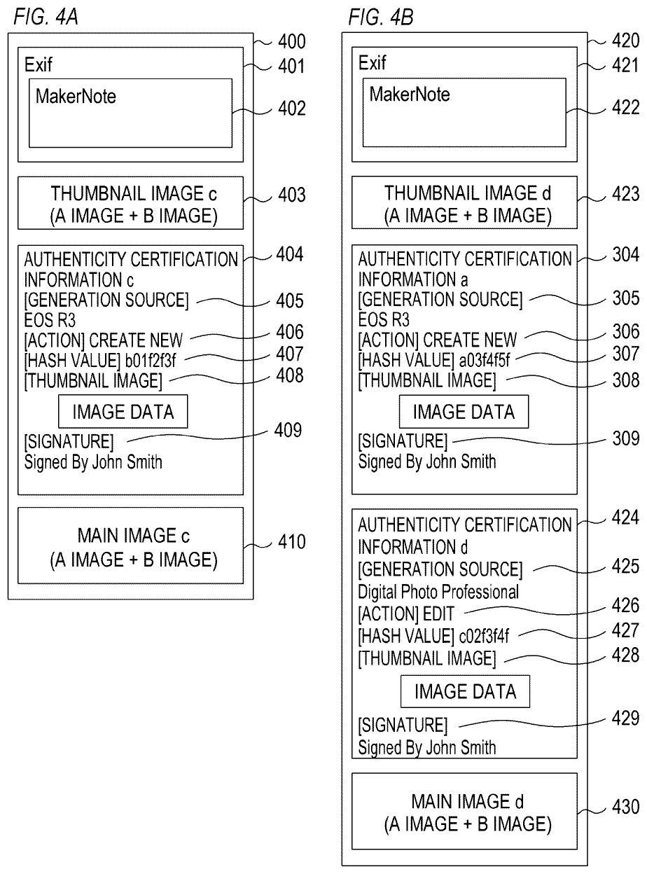

FIGS. 4A and 4B are diagrams illustrating an outline of recorded contents of an image file (image data) in JPEG format. FIG. 4A illustrates an image file 400 in JPEG format generated by developing an image file 300 in RAW format. The image file 400 is an example of a file that does not include authenticity certification information indicating that the file is edited. The image file 400 recorded after development includes regions in which Exif 401, a thumbnail image c (A image+B image) 403, authenticity certification information c 404, and a main image c (A image+B image) 410 are recorded.

Metadata according to the Exif standard generated by the metadata generation and analysis unit 70 on the basis of the editing result and MakerNote 402 are recorded in the region of the Exif 401. The image file 400 is an image file obtained by editing and developing the image file 300 in RAW format by changing a focus position, and “create new” is recorded in an action 406. As the hash value 407, for example, hash values of the edited main image c (A image+B image) 410, the thumbnail image c (A image+B image) 403, and the Exif 401 are recorded.

FIG. 4B illustrates an image file 420 in JPEG format generated by developing an image file 300 in RAW format. The image file 420 is an example of a file that includes authenticity certification information d 424 indicating that the file is edited. The image file 420 recorded after development includes regions in which Exif 421, a thumbnail image d (A image+B image) 423, authenticity certification information a 304, the authenticity certification information d 424, and a main image d (A image+B image) 430 are recorded.

Metadata according to the Exif standard generated by the metadata generation and analysis unit 70 on the basis of the editing result and MakerNote 422 are recorded in the region of the Exif 421. The authenticity certification information a 304 is authenticity certification information duplicated from the image file 300 which is the editing source. In a case where the image file 300 which is the editing source is edited, the authenticity certification information d 424 is assigned to the edited image file 420. The authenticity certification information d 424 includes history information indicating that the file is edited.

The image file 420 includes information obtained by copying the authenticity certification information a 304 recorded in the image file 300 which is the editing source, and authenticity certification information d 424 indicating that the file is edited. The authenticity certification information d 424 is added, and thus, the image file 420 can detect an editing history from the image file 300 in RAW format which is the editing source. The action 426 of the authenticity certification information d 424 is recorded as “edit”. As the hash value 427, for example, hash values of the edited main image d (A image+B image) 430, the thumbnail image d (A image+B image) 423, and the Exif 421 are recorded.

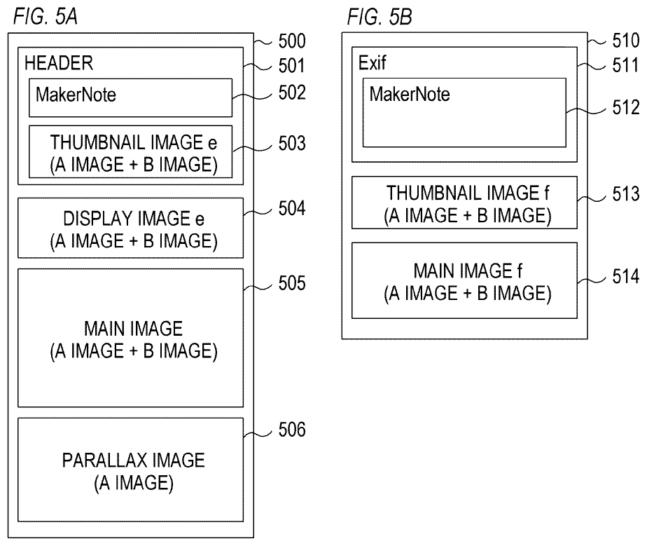

FIGS. 5A and 5B are diagrams illustrating an outline of recorded contents of an image file (image data) not including authenticity certification information. FIG. 5A illustrates an image file 500 recorded without the authenticity certification information in RAW format. The image file 500 includes regions in which a header 501, a display image e (A image+B image) 504, a main image (A image+B image) 505, and a parallax image (A image) 506 are recorded. Metadata according to the Exif standard generated by the metadata generation and analysis unit 70, MakerNote 502, and a thumbnail image e (A image+B image) 503 are recorded in the region of the header 501.

FIG. 5B illustrates an image file 510 recorded without the authenticity certification information in JPEG format. The image file 510 includes a region where Exif 511, thumbnail image f (A image+B image) 513, and main image f (A image+B image) 514 are recorded. Metadata according to the Exif standard generated by the metadata generation and analysis unit 70 and MakerNote 512 are recorded in the region of Exif 511.

### First Embodiment

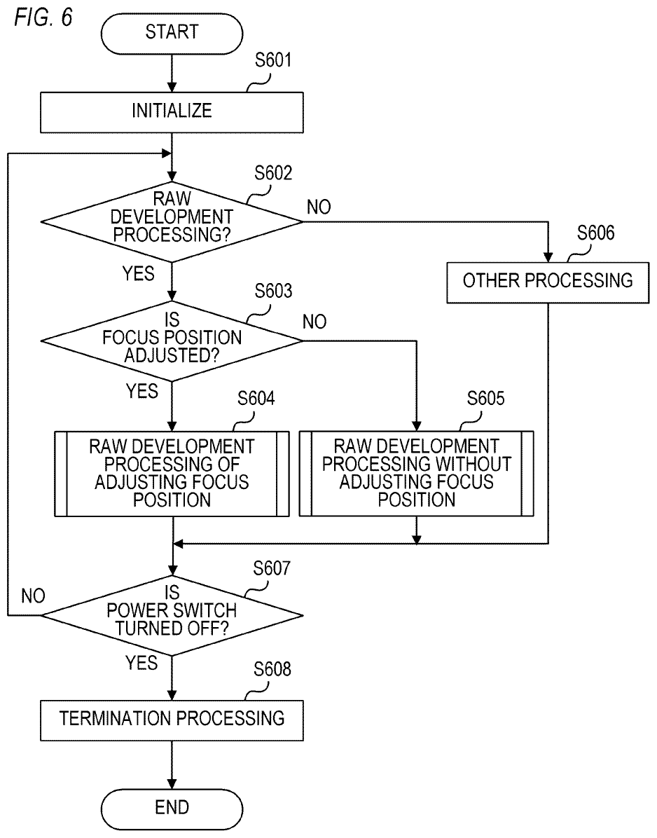

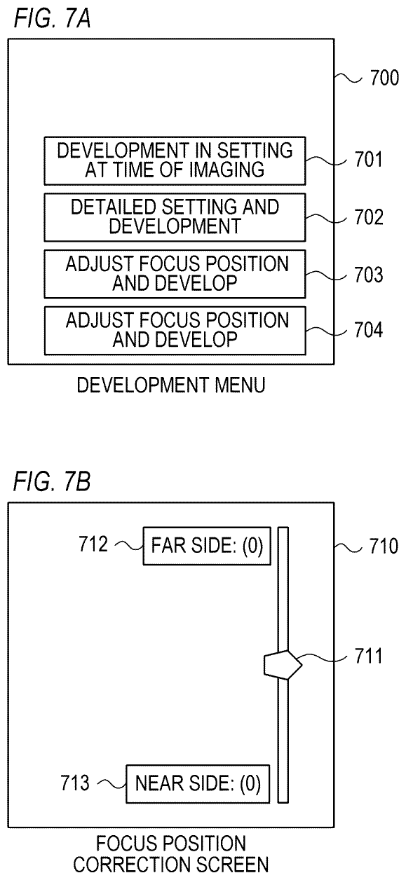

Processing of the digital camera 100 will be described with reference to FIGS. 6, 7A, and 7B. FIG. 6 is a flowchart illustrating the processing of the digital camera 100. The processing illustrated in FIG. 6 is started when a power switch included in the operation unit 63 is operated and the power supply 80 is switched on.

In step S601, the system control unit 50 initializes a flag, a control variable, and the like used for the processing of the digital camera 100. In step S602, the system control unit 50 determines whether or not an instruction about RAW development processing is given. For example, a user can give an instruction about the RAW development processing from a menu screen displayed on the display unit 23 by operating a button included in the operation unit 63. In addition, the user may operate a graphical user interface (GUI) button displayed on the display unit 23 to give the instruction about the RAW development processing.

FIG. 7A illustrates a menu screen 700 for giving the instruction about the RAW development processing. The menu screen 700 displays items 701 to 704. The item 701 is an item for giving an instruction to perform development by using parameters recorded in a RAW image file at the time of imaging. The item 702 is an item for giving an instruction to perform development after setting (detailed setting) development parameters such as exposure, white balance, color space, and contrast on another screen. The item 703 is an item for giving an instruction to perform development by adjusting a focus position. The item 704 is an item for giving an instruction to stop development processing.

In a case where an instruction about the RAW development processing is given (YES in step S602), the processing proceeds to step S603. In a case where the instruction about the RAW development processing is not given (NO in step S602), the processing proceeds to step S606. In the example of FIG. 7A, in a case where the items 701 to 703 are selected, the system control unit 50 determines that the instruction about the RAW development processing is given. In addition, in a case where the item 704 is selected, the system control unit 50 determines that the instruction about the RAW development processing is not given.

In step S603, the system control unit 50 determines whether or not an instruction about the RAW development processing with adjusting the focus position is given. In a case where the instruction about the RAW development processing with adjusting the focus position is given (YES in step S603), the processing proceeds to step S604. In a case where an instruction about the RAW development processing without adjusting the focus position is given (NO in step S603), the processing proceeds to step S605.

In the example of FIG. 7A, in a case where the item 703 is selected, the system control unit 50 determines that the instruction about the RAW development processing with adjusting the focus position is given. The focus position can be adjusted by changing a composition ratio when the A image and the B image having different focuses are combined. The “focus” herein may be interpreted as a “sense of resolution”. In addition, in a case where the items 701 and 702 are selected, since development is performed by using other parameters without adjusting the focus position, the system control unit 50 determines that the instruction about the RAW development processing without adjusting the focus position is given.

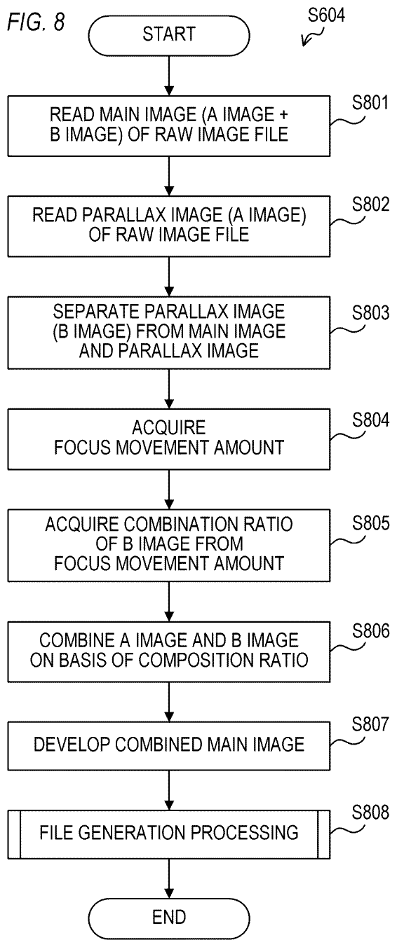

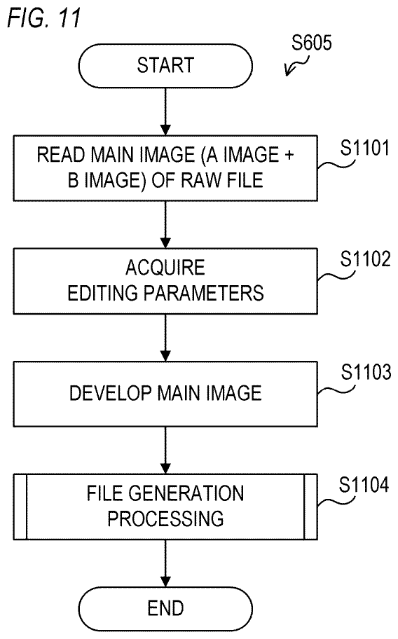

In step S604, the system control unit 50 executes the RAW development processing with adjusting the focus position. Details of the RAW development processing with adjusting the focus position in step S604 will be described with reference to FIG. 8. In step S605, the system control unit 50 executes the RAW development processing without adjusting the focus position. Details of the RAW development processing without adjusting the focus position in step S605 will be described with reference to FIG. 11. In step S606, the system control unit 50 executes processing of the digital camera 100 other than the RAW development processing.

In step S607, the system control unit 50 determines a setting position of the power switch included in the operation unit 63, and determines whether or not the power switch is set to OFF. When the power switch is set to ON (NO in step S607), the processing returns to step S602. When the power switch is set to OFF (YES in step S607), the processing proceeds to step S608.

In step S608, the system control unit 50 executes predetermined termination processing. The predetermined termination processing includes, for example, processing of protecting the imaging unit by terminating display on the display unit 23 and closing the barrier 9. In addition, the predetermined termination processing includes processing of recording setting values of parameters including a flag, a control variable, and the like, a set mode, and the like in the nonvolatile memory 51. In addition, the predetermined termination processing includes processing of stopping power supply to a portion where power supply is unnecessary. When the termination processing of step S608 is completed, the processing illustrated in FIG. 6 is terminated.

The RAW development processing with adjusting the focus position will be described with reference to FIG. 8. The RAW development processing illustrated in FIG. 8 represents details of the processing in step S604 in FIG. 6. In step S801, the system control unit 50 reads the main image (A image+B image) 311 of the image file 300 in RAW format which is a target of the development processing from the recording medium 91 to the memory 25. In step S802, the system control unit 50 reads the parallax image (A image) 312 of the image file 300 which is the target of the development processing from the recording medium 91 to the memory 25.

In step S803, the system control unit 50 separates a parallax image (B image) by using the main image (A image+B image) 311 and the parallax image (A image) 312 loaded onto the memory 25. The system control unit 50 writes the separated parallax image (B image) to the memory 25.

In steps S801 to S803, the system control unit 50 can acquire the parallax image (A image) 312 and the parallax image (B image), as a plurality of images having different focuses. That is, the image file 300 is configured to be able to acquire the parallax image (A image) 312 and the parallax image (B image) having different focuses from the main image (A image+B image) 311 and the parallax image (A image) 312.

In step S804, the system control unit 50 acquires a focus movement amount. The system control unit 50 may acquire the focus movement amount input via the operation unit 63 on a setting screen displayed on the display unit 23, or may acquire the focus movement amount on the basis of an operation of the user on the GUI displayed on the display unit 23.

FIG. 7B illustrates a focus position correction screen 710. The system control unit 50 can acquire the focus movement amount on the basis of an operation of the user on the focus position correction screen 710. The focus position correction screen 710 displays a focus position adjustment part 711, a movement amount (far side) 712, and a movement amount (near side) 713. The movement amount (far side) 712 indicates a movement amount of the focus from a center to a far side. The movement amount (near side) 713 indicates a movement amount of the focus from the center to a near side. The user can select (set) the focus movement amount by moving the focus position adjustment part 711 to the far side or the near side. The system control unit 50 can acquire the focus movement amount selected by the user by moving the focus position adjustment part 711.

In step S805, the system control unit 50 acquires a composition ratio of the parallax image (B image) by using the focus movement amount acquired in step S804. For example, when the movement of the focus is in a near direction, the system control unit 50 determines the composition ratio so as to adjust the focus position to the near side. When the movement of the focus is in a far direction, the system control unit 50 determines the composition ratio so as to adjust the focus position to the far side.

In step S806, the system control unit 50 changes a composition ratio between the parallax image (B image) and the parallax image (A image) in accordance with the composition ratio acquired in step S805. The system control unit 50 can generate the main image (A image+B image) with the adjusted focus movement amount by combining the parallax image (B image) and the parallax image (A image) on the basis of the changed composition ratio. The generated main image (A image+B image) is written to the memory 25.

In step S807, the system control unit 50 causes the image processing unit 20 and the memory control unit 22 to develop the main image (A image+B image) combined in step S806. The combined main image (A image+B image) is an image in which the focus position is adjusted. The main image (A image+B image) which is a development result is written to the memory 25.

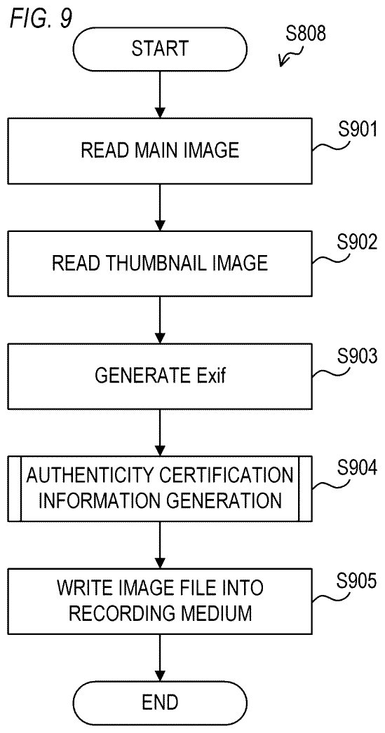

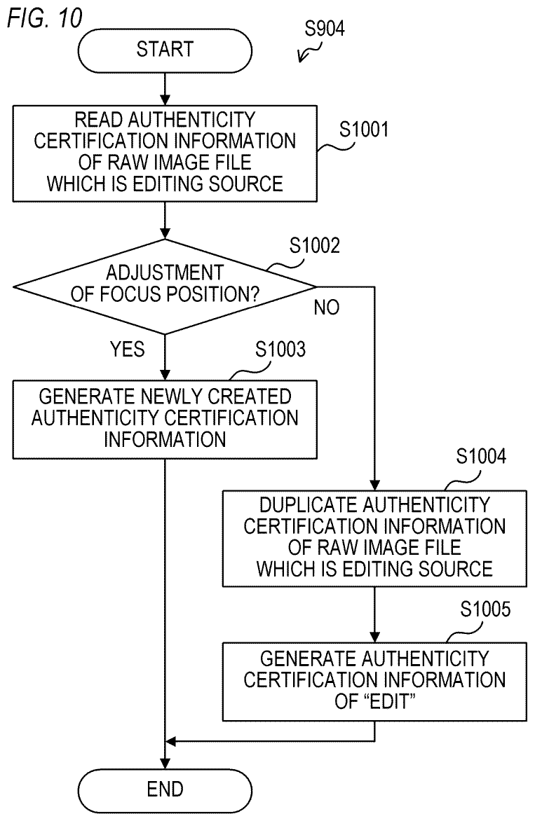

In step S808, the system control unit 50 reads the development result from the memory 25 and executes file generation processing. Details of the file generation processing in step S808 will be described with reference to FIGS. 9 and 10. The system control unit 50 records the image file generated in step S808 in the recording medium 91, and the RAW development processing illustrated in FIG. 8 is terminated. FIG. 4A is an example of the image file generated by the RAW development processing illustrated in FIG. 8.

In the RAW development processing illustrated in FIG. 8, the system control unit 50 changes the composition ratio between the parallax image (A image) and the parallax image (B image), and combines and develops the images. As a result, the system control unit 50 can generate an image file in which the focus position is finely adjusted within a range in which a focus position at the time of imaging can be adjusted by the recorded parallax image (A image) and parallax image (B image).

The file generation processing according to the first embodiment will be described with reference to FIG. 9. The file generation processing illustrated in FIG. 9 represents details of the processing of step S808 in FIG. 8. In step S901, the system control unit 50 reads the main image c (A image+B image) 410 from the development result recorded in the memory 25. In step S902, the system control unit 50 reads the thumbnail image c 403 from the development result of the memory 25.

In step S903, the system control unit 50 generates the Exif 401. The system control unit 50 records, as the metadata included in the Exif 401, information taken over from the image file 300 in RAW format which is the editing source, information updated at the time of editing such as an editing time of the RAW development processing, and the like in the memory 25.

The system control unit 50 may acquire various types of setting information at the time of the RAW development processing from the development result of the memory 25 and record, as the metadata, the information in the Exif 401. The setting information at the time of the RAW development processing includes, for example, information of whether or not the focus position is adjusted in the RAW development processing, that is, whether or not the composition ratio between the parallax image (A image) and the parallax image (B image) is changed. In addition, the setting information at the time of the RAW development processing may include setting information such as image processing such as background blurring, trimming, resizing, and the like.

In step S904, the system control unit 50 generates authenticity certification information to be assigned as the history information to the image file 400. The system control unit 50 generates the authenticity certification information c 404 from the pieces of data of the main image c (A image+B image) 410, the thumbnail image c (A image+B image) 403, and the Exif 401 read to the memory 25, and records the authenticity certification information in the memory 25. Details of generation processing of the authenticity certification information in step S904 will be described with reference to FIG. 10.

In step S905, the system control unit 50 writes the pieces of data of the Exif 401, the thumbnail image c (A image+B image) 403, the authenticity certification information c 404, and the main image c (A image+B image) 410 in the memory 25 to the recording medium 91. The system control unit 50 can generate the image file 400 by writing the pieces of data to the recording medium 91 according to a predetermined file format.

The generation processing of the authenticity certification information according to the first embodiment will be described with reference to FIG. 10. The authenticity certification information generation processing illustrated in FIG. 10 is the detailed processing of step S904 of FIG. 9. In step S1001, the system control unit 50 reads the authenticity certification information a 304 of the image file 300 in RAW format which is the editing source.

In step S1002, the system control unit 50 determines whether or not the focus position is adjusted in the RAW development processing, that is, whether or not the composition ratio between the parallax image (A image) and the parallax image (B image) is changed. The system control unit 50 can determine whether or not the focus position is adjusted in the RAW development processing on the basis of the setting information (metadata) acquired in order to generate the Exif 401 in step S903 of FIG. 9. In a case where the focus position is adjusted in the RAW development processing (YES in step S1002), the processing proceeds to step S1003. In a case where the focus position is not adjusted in the RAW development processing (NO in step S1002), that is, in a case where editing different from the adjustment of the focus position is performed on the image file 300, the processing proceeds to step S1004.

In step S1003, the system control unit 50 generates the authenticity certification information c 404 of “create new”. The authenticity certification information c 404 of “create new” is history information indicating that the image file 400 illustrated in FIG. 4A is not edited. Even in a case where the composition ratio between the parallax image (A image) and the parallax image (B image) is changed in order to adjust the focus position, since the editing is minor, the system control unit 50 assigns, to the image file 400, the history information indicating that the file is not edited. The action 406 of the authenticity certification information c 404 is recorded as “create new”. As described above, the system control unit 50 does not consider a change in the composition ratio between the parallax image (A image) and the parallax image (B image) for adjusting the focus position as the editing of the image file.

In step S1004, the system control unit 50 duplicates the authenticity certification information a 304 of the image file 300 read in step S1001 on the memory 25. The duplicated authenticity certification information a 304 is included in the edited image file 420 in JPEG format.

In step S1005, the system control unit 50 generates the authenticity certification information d 424 of “edit” after the authenticity certification information a 304 duplicated in step S1004. In the image file 420 illustrated in FIG. 4B, since editing different from the adjustment of the focus position is performed, the authenticity certification information d 424 of “edit” is the history information indicating that the image file 420 is edited. The action 426 of the authenticity certification information d 424 is recorded as “edit”.

In the first embodiment described above, in a case where the RAW development processing with adjusting the focus position is performed, the system control unit 50 generates the image file 400 by assigning the authenticity certification information indicating “create new” and not assigning the authenticity certification information indicating the file is edited. As a result, the image file 400 on which minor editing such as fine adjustment of the focus position is performed in the RAW development processing has the authenticity certification information of “create new”, and can be handled as an unedited image file.

Note that, in a case where editing different from the adjustment of the focus position is performed together with the adjustment of the focus position in the RAW development processing, the system control unit 50 considers that the image file is edited. In this case, the system control unit 50 generates an image file by assigning the authenticity certification information indicating that the file is edited. On the other hand, in a case where only the adjustment of the focus position is performed, the system control unit 50 generates an image file by assigning the authenticity certification information indicating that the file is not edited.

### Second Embodiment

A second embodiment relates to the RAW development processing without adjusting the focus position. The RAW development processing without adjusting the focus position will be described with reference to FIG. 11. The RAW development processing illustrated in FIG. 11 represents details of the processing in step S605 in FIG. 6.

In step S1101, the system control unit 50 reads the main image (A image+B image) 311 of the image file 300 in RAW format which is the target of the development processing from the recording medium 91 to the memory 25.

In step S1102, the system control unit 50 acquires editing parameters used in the RAW development processing. The editing parameters are, for example, parameters such as exposure (brightness), white balance, color space, contrast, clarity, and recorded image quality. The system control unit 50 may read and acquire setting values of the editing parameters recorded at the time of imaging from the image file 300. In addition, the system control unit 50 may acquire the setting values of the editing parameters set by the user via the GUI displayed on the display unit 23 or the operation unit 63.

In step S1103, the system control unit 50 causes the image processing unit 20 and the memory control unit 22 to develop the main image (A image+B image) read to the memory 25 by using the editing parameters acquired in step S1102. The main image (A image+B image) which is a development result is written to the memory 25.

In step S1104, the system control unit 50 reads the development result from the memory 25 and executes the file generation processing. Details of the file generation processing in step S1104 are similar to the processing described in FIGS. 9 and 10. The system control unit 50 records the image file generated in step S1104 in the recording medium 91.

In the file generation processing in step S1104, since the RAW development processing without adjusting the focus position is performed in step S1002 in FIG. 10, the system control unit 50 executes the processing in steps S1004 and S1005. As illustrated in FIG. 4B, the authenticity certification information generated in step S1104 includes the authenticity certification information a 304 and the authenticity certification information d 424.

In the second embodiment described above, the system control unit 50 performs the RAW development processing by using the editing parameters, instead of performing composition and development by changing the composition ratio between the parallax image (A image) and the parallax image (B image) in order to adjust the focus position. For example, the system control unit 50 can generate an image file having a finish different from that at the time of imaging the RAW image file by changing the setting values of the editing parameters such as exposure and white balance and performing the RAW development processing. In a case where the RAW development processing is executed by using the editing parameters instead of the adjustment of the focus position, the system control unit 50 generates the image file including the pieces of authenticity certification information of “create new” and “edit”. Therefore, in a case where editing other than fine adjustment of the image is performed, the user can confirm the history information indicating that the file is edited.

### Third Embodiment

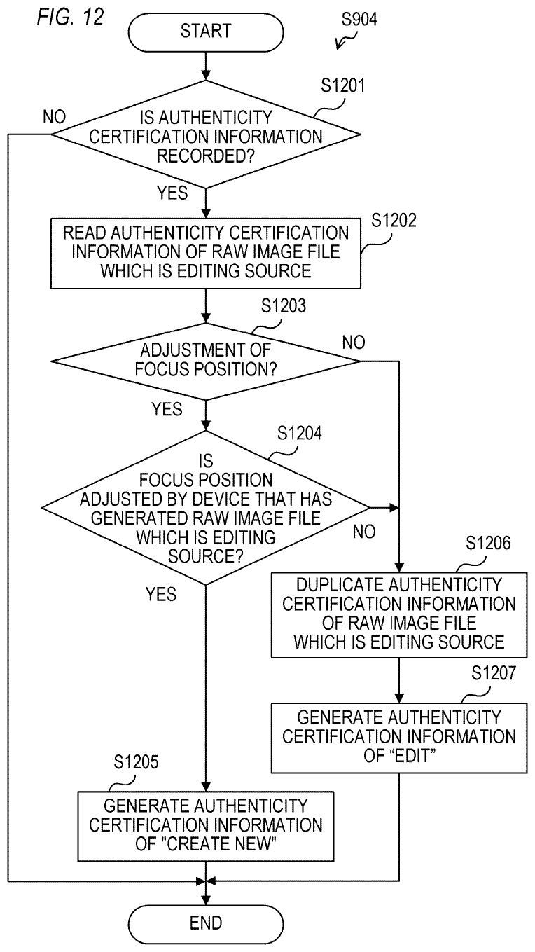

A third embodiment is an embodiment in which the authenticity certification information of “create new” is generated in a case where the focus position is adjusted by the same device as that at the time of imaging and the authenticity certification information of “edit” is generated in a case where the focus position is adjusted by a device different from that at the time of imaging. The generation processing of the authenticity certification information according to the third embodiment will be described with reference to FIG. 12. The generation processing of the authenticity certification information illustrated in FIG. 12 represents details of the processing of step S904 of FIG. 9.

In step S1201, the system control unit 50 determines whether or not the authenticity certification information is recorded in the RAW image file which is the target of the development processing read in the memory 25.

In a case where the authenticity certification information is not recorded in the RAW image file (NO in step S1201), in other words, in a case where the history information is not included in the RAW image file, the processing illustrated in FIG. 12 is terminated. In a case where the authenticity certification information is not recorded in the RAW image file, the system control unit 50 does not assign the authenticity certification information including the history information to the edited image file.

For example, FIG. 5A illustrates the image file 500 in RAW format in which the authenticity certification information is not recorded. In addition, FIG. 5B illustrates the image file 510 in JPEG format generated by developing the image file 500 in which the authenticity certification information is not recorded. The authenticity certification information is not recorded in the image file 510.

In a case where the authenticity certification information is recorded in the RAW image file (YES in step S1201), the processing proceeds to step S1202. In step S1202, the system control unit 50 reads the authenticity certification information a 304 of the image file 300 in RAW format which is the editing source.

In step S1203, the system control unit 50 determines whether or not the focus position is adjusted in the RAW development processing, that is, whether or not the composition ratio between the parallax image (A image) and the parallax image (B image) is changed. The system control unit 50 can determine whether or not the focus position is adjusted in the RAW development processing on the basis of the setting information (metadata) acquired in order to generate the Exif 401 in step S903 of FIG. 9. In a case where the focus position is not adjusted in the RAW development processing (NO in step S1203), the processing proceeds to step S1206. In a case where the focus position is adjusted in the RAW development processing (YES in step S1203), the processing proceeds to step S1204.

In step S1204, the system control unit 50 determines whether or not the focus position is adjusted by a device that has generated the image file in RAW format which is the editing source. For example, the system control unit 50 can acquire information of the device that has generated the image file which is the editing source on the basis of the information of the generation source recorded in the authenticity certification information of “create new”. The system control unit 50 can determine whether or not the focus position is adjusted by the device that has generated the image file which is the editing source by comparing the information of the device that has generated the image file in RAW format which is the editing source with the information of the device that has adjusted the focus position. In addition, the system control unit 50 may determine whether or not the focus position is adjusted by the device that has generated the image file as the editing source on the basis of the metadata recorded in the header.

In a case where it is determined that the focus position is adjusted by the device that has generated the image file as the editing source (YES in step S1204), the processing proceeds to step S1205. In a case where it is determined that the focus position is adjusted by a device other than the device that has generated the image file which is the editing source (NO in step S1204), the processing proceeds to step S1206.

In step S1205, the system control unit 50 generates the authenticity certification information c 404 of “create new”, and assigns the history information indicating that the file is not edited to the image file 400. That is, the system control unit 50 does not consider the change in the composition ratio between the parallax image (A image) and the parallax image (B image) for adjusting the focus position in the device that generated the image file which is the editing source, as the editing of the image file. The processing of generating the authenticity certification information of “create new” is similar to the processing of step S1003 in FIG. 10.

In step S1206, the system control unit 50 duplicates the authenticity certification information a 304 of the image file 300 which is the editing source. In step S1207, the system control unit 50 generates the authenticity certification information d 424 of “edit”, and assigns the history information indicating that the file is edited to the image file 420. That is, the system control unit 50 considers the change in the composition ratio between the parallax image (A image) and the parallax image (B image) for adjusting the focus position in the device other than the device that generated the image file which is the editing source, as the editing of the image file. The processing in steps S1206 and S1207 is similar to the processing in steps S1004 and S1005 in FIG. 10.

In the third embodiment described above, in a case where the authenticity certification information is not recorded in the RAW image file which is the editing source, the system control unit 50 does not record the authenticity certification information in the image file after the development processing regardless of whether or not the development processing is performed by adjusting the focus position. In addition, in a case where the focus position is adjusted by changing the composition ratio in the device other than the device that has generated the image data, the system control unit 50 assigns the history information indicating that the file is edited to the image data. As a result, it is possible to determine that the image data is not edited in a case where the focus position is adjusted by the device that has generated the image data, and it is possible to determine that the image data is edited in a case where the focus position is adjusted by the device other than the device that has generated the image data.

Note that the image file which is the editing source is not limited to the image file recorded in RAW format, and may be in another format as long as the image file is image data configured to be able to acquire a plurality of images with different focuses. For example, the image file which is the editing source may be in JPEG format, High Efficiency Image File Format (HEIF format), or TIFF format. The system control unit 50 can generate an image file in which the focus position is adjusted by changing a composition ratio between a plurality of images (the parallax image (A image) and the parallax image (B image)) having different focuses that can be acquired from the image files in the formats.

In addition, the edited image file to which the history information is assigned may have the same file format as or a different file format from the image file which is the editing source. The edited image file is, for example, JPEG format, HEIF format, or TIFF format.

Note that the above-described various types of control may be processing that is carried out by one piece of hardware (e.g., processor or circuit), or otherwise. Processing may be shared among a plurality of pieces of hardware (e.g., a plurality of processors, a plurality of circuits, or a combination of one or more processors and one or more circuits), thereby carrying out the control of the entire device.

Also, the above processor is a processor in the broad sense, and includes general-purpose processors and dedicated processors. Examples of general-purpose processors include a central processing unit (CPU), a micro processing unit (MPU), a digital signal processor (DSP), and so forth. Examples of dedicated processors include a graphics processing unit (GPU), an application-specific integrated circuit (ASIC), a programmable logic device (PLD), and so forth. Examples of PLDs include a field-programmable gate array (FPGA), a complex programmable logic device (CPLD), and so forth.

The embodiment described above (including variation examples) is merely an example. Any configurations obtained by suitably modifying or changing some configurations of the embodiment within the scope of the subject matter of the present disclosure are also included in the present disclosure. The present disclosure also includes other configurations obtained by suitably combining various features of the embodiment.

According to the present disclosure, it is possible to provide an image processing apparatus capable of handling an image as an unedited image even though minor editing processing such as adjustment of a focus position is performed.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2025-042422, filed Mar. 17, 2025, which is hereby incorporated by reference herein in its entirety.

What is claimed is:

1. An image processing apparatus comprising:
a processor; and
a memory storing a program which, when executed by the processor, causes the image processing apparatus to:
execute acquisition processing of acquiring image data configured to be able to acquire a plurality of images with different focuses; and
execute assignment processing of assigning, in a case where the image data is edited, history information to an edited image data,
wherein, in the assignment processing, a change in a composition ratio when the plurality of images are combined is not considered as editing of the image data.

2. The image processing apparatus according to claim 1, wherein, in the assignment processing, in a case where only the change in the composition ratio is performed, history information indicating that the image data is not edited is assigned to the image data.

3. The image processing apparatus according to claim 1, wherein, in the assignment processing, in a case where editing different from the change in the composition ratio is performed on the image data, history information indicating that the image data is edited is assigned to the edited image data.

4. The image processing apparatus according to claim 3, wherein the editing different from the change in the composition ratio includes at least one of conversion, cropping, resizing, composition, and deletion of the image data.

5. The image processing apparatus according to claim 3, wherein the editing different from the change in the composition ratio includes changing setting of at least one of exposure, white balance, color space, and contrast for the image data.

6. The image processing apparatus according to claim 1, wherein, in the assignment processing, in a case where the image data does not include the history information, the history information is not assigned to the edited image data.

7. The image processing apparatus according to claim 1,
wherein, in the assignment processing,
the change in the composition ratio in a device that has generated the image data is not considered as the editing of the image data, and
the change in the composition ratio in a device other than the device that has generated the image data is considered as the editing of the image data.

8. The image processing apparatus according to claim 1, wherein the plurality of images are images imaged at a same exposure timing.

9. The image processing apparatus according to claim 1, wherein the image data is in RAW format, JPEG format, HEIF format, or TIFF format.

10. An image processing method comprising:
acquiring image data configured to be able to acquire a plurality of images with different focuses; and
assigning, in a case where the image data is edited, history information to an edited image data,
wherein, in the assigning, a change in a composition ratio when the plurality of images are combined is not considered as editing of the image data.

11. A non-transitory computer readable medium that stores a program, wherein the program causes a computer to execute an image processing method comprising:
acquiring image data configured to be able to acquire a plurality of images with different focuses; and
assigning, in a case where the image data is edited, history information to an edited image data,
wherein, in the assigning, a change in a composition ratio when the plurality of images are combined is not considered as editing of the image data.
